(19) United States
(12) Patent Application Publication
(10) Pub. No.: US 2022/0393546 A1
(43) Pub. Date: Dec. 8, 2022

(54) MOTOR UNIT AND METHOD FOR MANUFACTURING MOTOR UNIT

(71) Applicant: NIDEC CORPORATION, Kyoto (JP)

(72) Inventors: Takayuki MAKINO, Kyoto (JP); Masato AONO, Kyoto (JP)

(21) Appl. No.: 17/750,395

(22) Filed: May 23, 2022

(30) Foreign Application Priority Data
Jun. 3, 2021 (JP) 2021-093574

(51) Int. Cl. H02K 7/00; H02K 5/16; H02K 7/08

(52) U.S. Cl. CPC H02K 7/003; H02K 5/163; H02K 7/085

(57) ABSTRACT

Provided are: a rotor having a shaft rotatable about a rotation axis; a stator that surrounds the rotor from a radially outer side; a housing that accommodates the rotor and the stator; a bearing that is arranged in the housing and rotatably supports the shaft; an extension shaft arranged at an end portion on one axial side of the shaft to contact the shaft; and a neutralizing member that is arranged in the housing and contacts the extension shaft. The extension shaft has a fixed portion radially overlapping the shaft. The fixed portion has a protrusion radially protruding toward the shaft.

### CROSS-REFERENCE TO RELATED APPLICATIONS

The present invention claims priority under 35 U.S.C. § 119 to Japanese Patent Application No. 2021-093574 filed on Jun. 3, 2021, the entire content of which is incorporated herein by reference.

### FIELD OF THE INVENTION

The present invention relates to a motor unit and a method for manufacturing a motor unit.

### BACKGROUND

Conventionally, a motor having a brush electrically connected to a housing at an end portion of a rotor shaft has been known.

However, in the motor having the brush described above, the contact area between the brush and the rotor shaft is small, and the electric resistance between the brush and the rotor shaft increases. As a result, a current hardly flows between the rotor shaft and the housing, and a potential difference is likely to be generated.

### SUMMARY

An exemplary motor unit of the present invention includes: a rotor having a shaft rotatable about a rotation axis; a stator that surrounds the rotor from a radially outer side; a housing that accommodates the rotor and the stator; a bearing that is arranged in the housing and rotatably supports the shaft; an extension shaft arranged at an end portion on one axial side of the shaft to contact the shaft; and a neutralizing member that is arranged in the housing and contacts the extension shaft. The extension shaft has a fixed portion radially overlapping the shaft. The fixed portion has a protrusion radially protruding toward the shaft.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a conceptual diagram of a motor unit of an preferred embodiment;

FIG. 2 is a cross-sectional view taken along a plane including a rotation axis of the motor unit;

FIG. 3 is an exploded perspective view of a shaft;

FIG. 4 is an exploded perspective view of an extension shaft;

FIG. 5 is a cross-sectional view of a fixed portion of the extension shaft taken along a plane orthogonal to a center line;

FIG. 6 is a cross-sectional view of the extension shaft attached to the shaft and the shaft taken along the plane including the rotation axis;

FIG. 7 is a cross-sectional view of the extension shaft attached to the shaft and the shaft taken along the plane including the rotation axis;

FIG. 8 is a cross-sectional view of an extension shaft, used in a motor unit of a first modification, taken along a plane orthogonal to a rotation axis;

FIG. 9 is a cross-sectional view of an extension shaft, used in a motor unit of a second modification, taken along a plane orthogonal to a rotation axis;

FIG. 10 is a cross-sectional view of an extension shaft and a shaft of a third modification taken along a plane including a rotation axis;

FIG. 11 is a cross-sectional view of an extension shaft and a shaft of a fourth modification taken along a plane including a rotation axis; and

FIG. 12 is a cross-sectional view of an extension shaft and a shaft of a fifth modification taken along a plane including a rotation axis.

### DETAILED DESCRIPTION

Hereinafter, a motor unit according to an preferred embodiment of the present invention will be described with reference to the drawings. Note that the scope of the present invention is not limited to the preferred embodiment described below, but includes any modification thereof within the scope of the technical idea of the present invention.

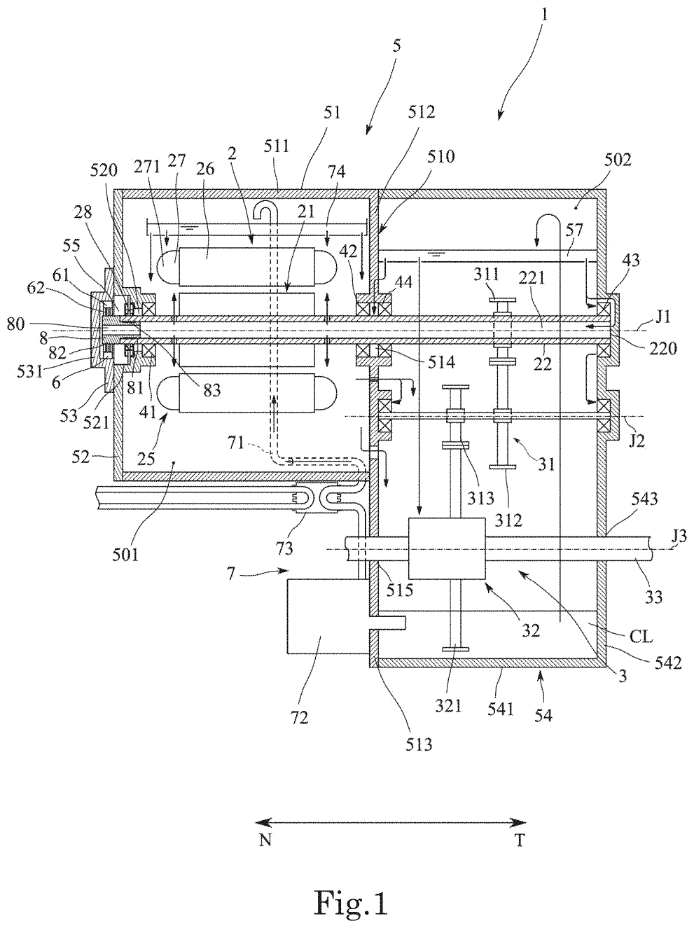

In the present specification, a direction parallel to a rotation axis J1 of a rotor 21 of a motor 2 is referred to as an “axial direction” of a motor unit 1. The one axial side N and the other axial side T are defined as illustrated in FIG. 1. In addition, radial direction orthogonal to the rotation axis J1 is simply referred to as a “radial direction”, and a circumferential direction around the rotation axis J1 is simply referred to as a “circumferential direction”. Further, a “parallel direction” described in the present specification includes not only a completely parallel direction, but also a substantially parallel direction. Then, “extending along” a predetermined direction or plane includes not only a case of extending strictly in a predetermined direction but also a case of extending in a direction inclined within a range of less than 45° with respect to the exact direction.

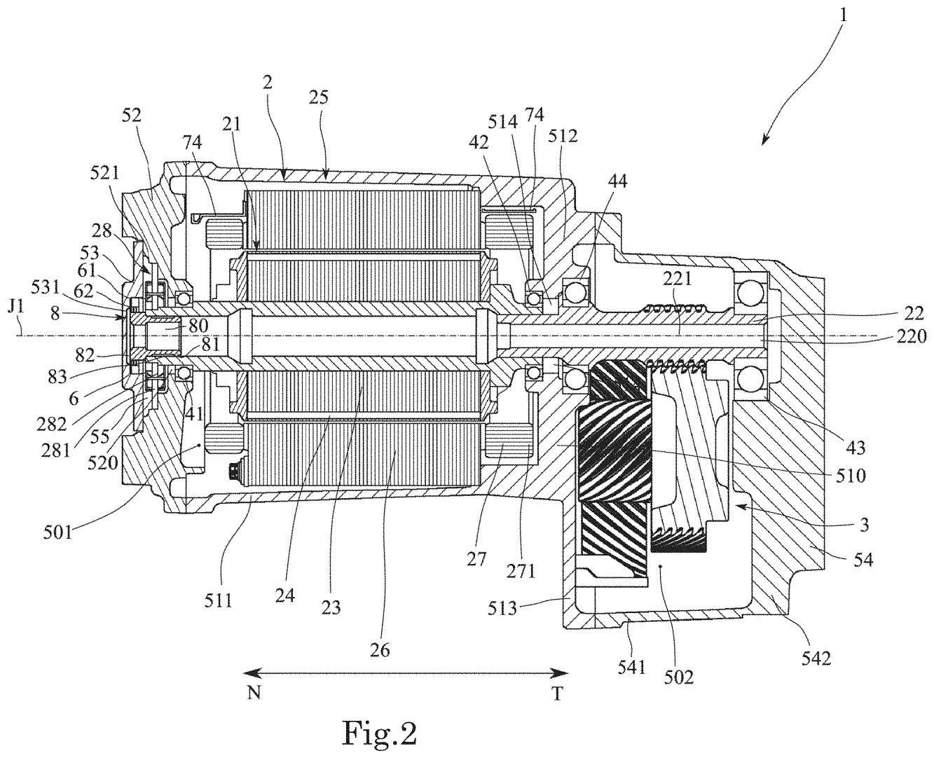

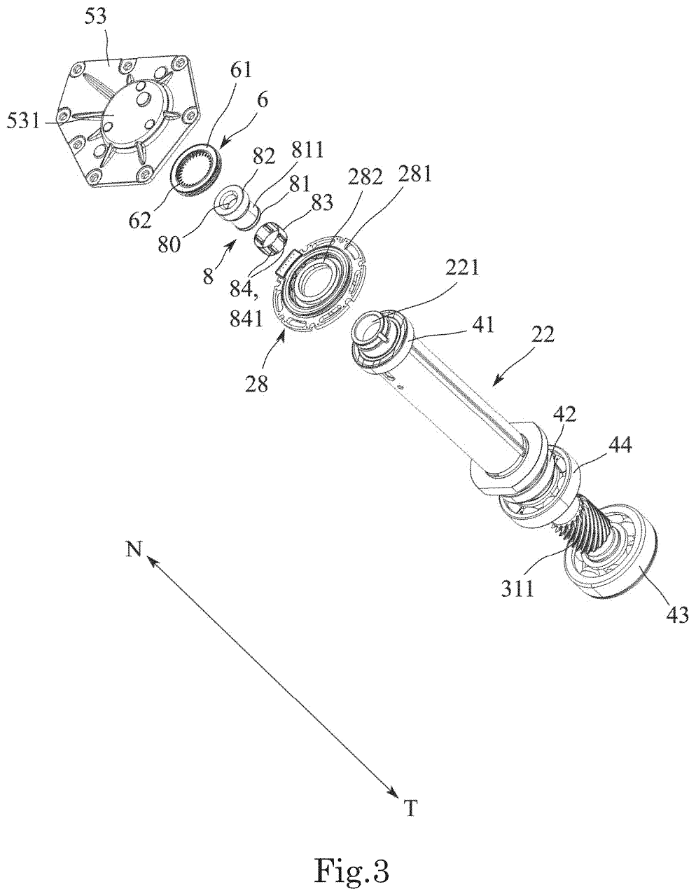

A motor unit 1 according to the preferred embodiment of the present invention will be described below with reference to the drawings. FIG. 1 is a schematic diagram of the motor unit 1 according to the preferred embodiment. FIG. 2 is a cross-sectional view taken along a plane including the rotation axis J1 of the motor unit 1. FIG. 3 is an exploded perspective view of a shaft 22. Note that FIG. 1 is only a conceptual diagram, and a layout and a dimension of each portion are not necessarily identical to those of the actual motor unit 1.

The motor unit 1 is mounted on a vehicle, such as a hybrid vehicle (HV), a plug-in hybrid vehicle (PHV), and an electric vehicle (EV), in which at least a motor is used as a power source. The motor unit 1 is used as the power source of the vehicle.

As illustrated in FIG. 1, the motor unit 1 includes a motor 2, a housing 5, a neutralizing member 6, and an extension shaft 8. The housing 5 accommodates the motor 2. The motor unit 1 further includes a gear portion 3 connected to the other axial side T of the shaft 22 and accommodated in the housing 5.

The motor 2 is a DC brushless motor. The motor 2 is driven by electric power from an inverter (not illustrated). The motor 2 includes the rotor 21 that rotates about the rotation axis J1 extending in the horizontal direction, and a stator 25 located radially outward of the rotor 21. That is, the stator 25 surrounds the rotor 21 from the radially outer side. The motor 2 is an inner rotor type motor in which the rotor 21 is rotatably arranged inward of the stator 25.

The rotor 21 rotates when electric power is supplied to the stator 25. As illustrated in FIG. 2, the rotor 21 includes the shaft 22, a rotor core 23, and a rotor magnet 24. The rotor 21 rotates about the rotation axis J1 extending in the horizontal direction.

The rotor 21 includes the shaft 22 rotatable about the rotation axis J1. The shaft 22 extends with the rotation axis J1 extending in the horizontal direction and in the vehicle width direction as a center. The shaft 22 rotates about the rotation axis J1. In the motor unit 1 of the present preferred embodiment, a lubricating oil CL as a coolant to be described later flows through a hollow portion 221 of the shaft 22. Therefore, the shaft 22 has the hollow portion 221 penetrating along the rotation axis J1 therein. That is, the shaft 22 has the hollow portion 221 opening at least at the end portion on the one axial side N. The hollow portion 221 includes an inlet 220 through which the lubricating oil CL flows into the hollow portion 221 on the other axial side T. As a result, it is possible to avoid blockage of the hollow portion 221 of the shaft 22. In addition, a conductive wire can be wired in the hollow portion 221 of the shaft 22, for example, since the shaft 22 has the hollow portion 221. Further, the weight of the shaft 22 can be reduced.

The shaft 22 is rotatably supported by the housing 5 through a first bearing 41, a second bearing 42, a third bearing 43, and a fourth bearing 44 to be described later. That is, the bearings 41, 42, 43, and 44 are arranged in the housing 5 to rotatably support the shaft 22.

Note that the shaft 22 can be divided into a portion in a motor accommodation space 501 and a portion in a gear portion accommodation space 502. When the shaft 22 is dividable, the divided shafts 22 can adopt a screw coupling using a male screw and a female screw, for example. Alternatively, the divided shafts 22 may be joined by a fixing method such as press-fitting or welding. When the fixing method such as press-fitting or welding is adopted, serrations combining recesses and protrusions extending in the axial direction may be adopted. With such a configuration, it is possible to reliably transmit the rotation. In addition, the shaft 22 may be formed as the single member.

The rotor core 23 is formed by laminating thin electromagnetic steel plates. The rotor core 23 is a columnar body extending along the axial direction. A plurality of the rotor magnets 24 are fixed to the rotor core 23. The plurality of rotor magnets 24 are arranged along the circumferential direction with magnetic poles arranged alternately.

As illustrated in FIG. 2, the stator 25 includes a stator core 26, a coil 27, and an insulator (not illustrated) interposed between the stator core 26 and the coil 27. The stator 25 is held by the housing 5. The stator core 26 includes a plurality of magnetic pole teeth (not illustrated) extending radially inward from an inner peripheral surface of an annular yoke.

The coil 27 is formed by winding a conductive wire around the magnetic pole teeth. The coil 27 is connected to an inverter unit (not illustrated) through a bus bar (not illustrated). The coil 27 has a coil end 271 protruding from an axial end surface of the stator core 26. The coil end 271 projects axially beyond an end portion of the rotor core 23 of the rotor 21.

A resolver 28 (see FIGS. 2, 3, and the like) is attached to an end portion on the one axial side N of the shaft 22. The resolver 28 is fixed to a position of the rotor 21, and a resolver stator 281 is fixed to a bearing holder 52, which will be described later, of the housing 5. A resolver rotor 282 is fixed to the shaft 22.

The resolver stator 281 has an annular shape, and the resolver rotor 282 has a disk shape. An inner peripheral surface of the resolver stator 281 and an outer peripheral surface of the resolver rotor 282 face each other in the radial direction. The resolver stator 281 periodically detects a position of the resolver rotor 282 when the rotor 21 rotates. As a result, the resolver 28 acquires information on the position of the rotor 21 from information on the position of the resolver rotor 282.

In addition, the bus bar (not illustrated) is arranged at an end portion on the one axial side N inside the housing 5. The bus bar connects the inverter unit (not illustrated) and the coil 27 and supplies electric power to the coil 27. The electric power is supplied to the coil 27 from the one axial side N.

The gear portion 3 includes a plurality of gears and is accommodated in the housing 5. As described above, the gear portion 3 is connected to the shaft 22 on the other axial side T. The gear portion 3 includes a deceleration portion 31 and a differential portion 32.

As illustrated in FIG. 1, the deceleration portion 31 is connected to the shaft 22. The deceleration portion 31 transmits the torque output from the motor 2 to the differential portion 32. The deceleration portion 31 reduces the rotation speed of the motor 2 according to a reduction ratio and increases the torque output from the motor 2 according to a reduction ratio.

The deceleration portion 31 is a speed reducer of a parallel-axis gearing type in which center axes of gears are arranged in parallel with each other. The deceleration portion 31 includes a first gear 311 which is an intermediate drive gear, a second gear 312 which is an intermediate gear, a third gear 313 which is a final drive gear, and an intermediate shaft 314.

The first gear 311 is arranged on an outer peripheral surface of the shaft 22. In the motor unit 1 of the present preferred embodiment, the first gear 311 and the shaft 22 are formed of the single member. The first gear 311 rotates about the rotation axis J1 together with the shaft 22. The intermediate shaft 314 extends along the intermediate axis J2 parallel to the rotation axis J1. Both end portions of the intermediate shaft 314 in the axial direction are rotatably supported by the housing 5 through the bearings. That is, the intermediate shaft 314 is rotatable about the intermediate axis J2.

The second gear 312 and the third gear 313 are arranged on the intermediate shaft 314. The second gear 312 meshes with the first gear 311. The third gear 313 meshes with a ring gear 321 of the differential portion 32. The torque of the shaft 22 is transmitted from the first gear 311 to the second gear 312. Then, the torque transmitted to the second gear 312 is transmitted to the third gear 313 through the intermediate shaft 314. The torque transmitted to the third gear 313 is transmitted to the ring gear 321 of the differential portion 32. In this manner, the deceleration portion 31 transmits the torque output from the motor 2 to the differential portion 32. The number of gears, gear ratios of the gears, and the like can be modified in various manners according to a desired reduction ratio.

The differential portion 32 transmits the torque output from the motor 2 to an output shaft 33. The output shaft 33 is attached to each of the left and right sides of the differential portion 32. For example, the differential portion 32 has a function of transferring the same torque to the left and right output shafts 33 while absorbing a speed difference between left and right drive wheels, that is, the output shafts 33 when the vehicle turns. The output shaft 33 projects to the outside of the housing 5. A drive shaft (not illustrated) connected to the drive wheels of the vehicle is connected to the output shaft 33.

In addition to these, the gear portion 3 may include a parking mechanism (not illustrated) that locks the vehicle when the operation of the motor unit 1 is stopped.

As illustrated in FIGS. 1, 2, and the like, the housing 5 includes a housing body 51, the bearing holder 52, a cover member 53, and a gear portion accommodation portion 54. The housing body 51, the bearing holder 52, and the gear portion accommodation portion 54 are made of, for example, a conductive material such as iron, aluminum, or an alloy thereof, in other words, metal, but are not limited thereto. Note that the housing body 51, the bearing holder 52, the cover member 53, and the gear portion accommodation portion 54 may be made of the same material or may be made of different materials. The housing body 51, the bearing holder 52, the cover member 53, and the gear portion accommodation portion 54 are preferably made of the same material in order to suppress contact corrosion of dissimilar metals at the contact portion.

The housing body 51 has a first tubular portion 511, a partition wall 512, and a protruding portion 513. The first tubular portion 511 is a tubular body extending in the axial direction. The stator core 26 is fixed inside the housing body 51. The first tubular portion 511 has an opening on the one axial side N. The housing 5 accommodates the rotor 21 and the stator 25.

The partition wall 512 expands radially inward from an end portion on the other axial side T of the first tubular portion 511. The partition wall 512 is provided with a through-hole 514 penetrating along the rotation axis J1. The through-hole 514 has a circular cross section, and its center line overlaps the rotation axis J1. Then, the shaft 22 is arranged to pass through the through-hole 514. The shaft 22 passing through the through-hole 514 is rotatably supported by the partition wall 512 through the second bearing 42 and the fourth bearing 44. The second bearing 42 is arranged on the one axial side N of the partition wall 512, and the fourth bearing 44 is arranged on the other axial side T of the partition wall 512. As a result, the shaft 22 is supported such that the intermediate portion in the axial direction is rotatable, and thus, deflection, bending, and the like of the shaft 22 are suppressed when the shaft 22 rotates.

The protruding portion 513 has a flat plate shape and extends vertically downward from the other axial side T of an outer peripheral surface of the first tubular portion 511. In the motor unit 1 according to the present preferred embodiment, the first tubular portion 511, the partition wall 512, and the protruding portion 513 are formed of the single member. The partition wall 512 and the protruding portion 513 form a side plate 510 that closes an end portion on the one axial side N of the gear portion accommodation portion 54.

A first drive shaft passage hole 515 is formed in the protruding portion 513. The first drive shaft passage hole 515 is a hole axially penetrating the protruding portion 513. The output shaft 33 passes through the first drive shaft passage hole 515 in a rotatable state. An oil seal (not illustrated) is provided between the output shaft 33 and the first drive shaft passage hole 515 to suppress leakage of the lubricating oil CL. An axle (not illustrated) that rotates the wheels is connected to a tip end of the output shaft 33.

The bearing holder 52 expands in the radial direction. The bearing holder 52 is fixed to the one axial side N of the first tubular portion 511. While the bearing holder 52 can be fixed to the first tubular portion 511 with a screw, for example, the method is not limited thereto, and a method of firmly fixing the bearing holder 52 to the first tubular portion 511, such as screwing or press-fitting, can be widely adopted.

As a result, the bearing holder 52 is electrically connected to the housing body 51. Here, a case where two members are electrically connected includes a case where the two members are physically contact each other and can be electrically conducted, and also includes a case where the two members are close to each other to an extent of being substantially at the same potential. That is, electrically connected members have the same or substantially same potential. Hereinafter, in a case where there is electrical connection, a similar configuration is assumed. In the motor unit 1 of the present preferred embodiment, the housing body 51 and the bearing holder 52 have the same potential.

In addition, the first tubular portion 511 and the bearing holder 52 are in close contact with each other. Here, the term “close contact” means to have such a sealing property that the lubricating oil CL inside the housing 5 does not leak to the outside and that foreign matter such as external water, or dust does not enter. It is assumed that the same configuration is applied below for the close contact.

The bearing holder 52 includes a recess 521 recessed from a surface on the one axial side N of the bearing holder 52 to the other axial side. The recess 521 has a through-hole 520, which penetrates in the axial direction, on a bottom surface. The center of the through-hole 520 coincides with the rotation axis J1, and the shaft 22 passes through the through-hole 520. The end portion on the one axial side N of the shaft 22 is arranged inside the recess 521.

The first bearing 41 is arranged on the other axial side T of the bearing holder 52. The shaft 22 passing through the through-hole 520 is rotatably supported by the bearing holder 52 through the first bearing 41.

The resolver stator 281 of the resolver 28 is fixed to the inside of the recess 521. When the resolver stator 281 is arranged in the bearing holder 52, its center line coincides with the rotation axis J1. Then, the resolver stator 281 is fixed to the bearing holder 52 by a screw (not illustrated). Note that the fixing of the resolver stator 281 to the bearing holder 52 is not limited to the screw, and a fixing method, such as press-fitting or adhesion, which can firmly fix the resolver stator 281 to the bearing holder 52 can be widely adopted.

In the motor unit 1, the shaft 22 passes through the through-hole 514 on the other axial side T of the rotor core 23, and has a portion on the one axial side N of the rotor core 23 passing through the through-hole 520. Then, both the axial sides of the shaft 22 across the rotor core 23 are rotatably supported by the housing 5 through the first bearing 41 and the second bearing 42. At this time, the shaft 22 is rotatable about the rotation axis J1.

The cover member 53 is attached to the one axial side N of the bearing holder 52. The cover member 53 covers the one axial side N of the recess 521 of the bearing holder 52, and is in close contact with the bearing holder 52. In addition, the bearing holder 52 and the cover member 53 are electrically connected. For this reason, the cover member 53 and the housing body 51 have the same potential. Then, the cover member 53 has a neutralizing member fixing recess 531. The neutralizing member fixing recess 531 is recessed from a surface on the other axial side T of the cover member 53, and a neutralizing ring 61 of a neutralizing member 6, which will be described later, is fixed thereto.

A region that is enclosed by covering the recess 521 of the bearing holder 52 with the cover member 53 and fixing the cover member 53 to the bearing holder 52 is an accommodation space 55. In a state where the stator 25 of the motor 2 is accommodated in the first tubular portion 511, the bearing holder 52 is attached to the one axial side N of the first tubular portion 511, and the cover member 53 is attached to the one axial side N of the bearing holder 52, whereby the end portion on the one axial side N of the shaft 22 is accommodated in the accommodation space 55. The accommodation space 55 is formed between the cover member 53 and the bearing holder 52.

As illustrated in FIGS. 1 and 2, the neutralizing member 6 and the resolver 28 are arranged side by side along the rotation axis J1 in the accommodation space 55.

The gear portion accommodation portion 54 has a recessed shape that opens to the one axial side N. The gear portion accommodation portion 54 has a second tubular portion 541 and a closing portion 542. An end portion on the one axial side N of the second tubular portion 541 is attached to the side plate 510. The second tubular portion 541 has a shape overlapping an outer edge of the side plate 510 in the axial direction. The second tubular portion 541 is fixed to the side plate 510 in a state of being in close contact with and in electrical contact with the side plate 510.

The second tubular portion 541 is fixed to the side plate 510 by screwing, for example, but the method is not limited thereto. For example, a fixing method capable of firmly fixing the second tubular portion 541 to the side plate 510, such as welding or press-fitting, can be widely adopted. An opening of the gear portion accommodation portion 54 is covered by the side plate 510.

The second tubular portion 541 and the closing portion 542 are formed of the single member. The closing portion 542 has a plate shape expanding radially inward from an end portion on the other axial side T of the second tubular portion 541. A space surrounded by the second tubular portion 541, the closing portion 542, and the side plate 510 is the gear portion accommodation space 502. The end portion on the other axial side T of the shaft 22 is rotatably supported by the closing portion 542 through the third bearing 43.

A second drive shaft passage hole 543 is formed in the closing portion 542. The second drive shaft passage hole 543 is a hole axially penetrating the closing portion 542. The output shaft 33 passes through the second drive shaft passage hole 543 in a rotatable state. An oil seal (not illustrated) is provided between the output shaft 33 and the second drive shaft passage hole 543 to suppress leakage of the lubricating oil CL. An axle (not illustrated) that rotates the wheels is connected to a tip end of the output shaft 33. Note that the output shaft 33 rotates about a differential axis J3.

The inside of the housing 5 is filled with the lubricating oil CL for lubricating gears and bearings of the gear portion 3. In the motor unit 1, the oil is also used to cool the motor 2. That is, the lubricating oil CL for lubricating the motor unit 1 is a coolant for cooling the motor.

As illustrated in FIG. 1, the lubricating oil CL is stored in a lower region of the gear portion accommodation space 502. A part of the differential portion 32 is immersed in the lubricating oil CL stored in the lower region of the gear portion accommodation space 502. The lubricating oil CL stored in the lower region of the gear portion accommodation space 502 is scraped up by the operation of the differential portion 32 and diffused into the gear portion accommodation space 502. The oil diffused into the gear portion accommodation space 502 is supplied to the respective gears arranged inside the gear portion accommodation space 502 and used for lubrication. In addition, a part of the lubricating oil CL diffused into the gear portion accommodation space 502 is also supplied to the respective bearings and used for lubrication.

As illustrated in FIG. 1, an oil reserve tray 57 is arranged in an upper region of the gear portion accommodation space 502. The oil reserve tray 57 opens upward. The scraped-up lubricating oil CL moves above the gear portion accommodation space 502 and flows into the oil reserve tray 57.

The lubricating oil CL accumulated in the oil reserve tray 57 flows into the hollow portion 221 of the shaft 22 from the inlet 220 at the end portion on the other axial side T of the shaft 22 through an oil supply path (not illustrated). The lubricating oil CL in the hollow portion 221 of the shaft 22 flows toward the one axial side N. The lubricating oil CL having flowed through the hollow portion 221 is sprayed toward the stator 25. As a result, the lubricating oil CL cools the stator 25.

Since the shaft 22 has a tubular shape, even when the lubricating oil CL is caused to flow into the hollow portion 221 of the shaft 22, the lubricating oil CL can be drawn from the inlet 220 by negative pressure generated by the airflow flowing out to the one axial side N during the rotation of the shaft 22. As a result, the lubricating oil CL can be supplied to the entire motor 2, and the motor 2 can be cooled stably. For this reason, the motor 2 can be driven stably.

The motor unit 1 has a coolant circulation portion 7 that circulates the lubricating oil CL. The coolant circulation portion 7 includes a pipe portion 71, a pump 72, an oil cooler 73, and a motor oil reservoir 74.

The pipe portion 71 is a pipe formed in the housing 5. The pipe portion 71 connects the pump 72 and the motor oil reservoir 74 arranged inside the first tubular portion 511, and supplies the lubricating oil CL to the motor oil reservoir 74. The pump 72 sucks the lubricating oil CL stored in the lower region of the gear portion accommodation space 502. The pump 72 is an electric pump, but is not limited thereto. For example, the motor unit 1 may be configured to be driven using part of the output of the output shaft 33.

The oil cooler 73 is arranged between the pump 72 of the pipe portion 71 and the motor oil reservoir 74. That is, the lubricating oil CL sucked by the pump 72 passes through the oil cooler 73 through the pipe portion 71, and is sent to the motor oil reservoir 74. For example, a refrigerant such as water supplied from the outside is supplied to the oil cooler 73. Then, heat is exchanged between the refrigerant and the lubricating oil CL to lower the temperature of the lubricating oil CL. Note that the oil cooler 73 used herein is a liquid-cooled type using a refrigerant, but is not limited thereto, and may be a so-called air-cooled type that cools with traveling air of the vehicle. The use of the oil cooler 73 can lower the temperature of the lubricating oil CL supplied to the motor oil reservoir 74, and the cooling efficiency of the motor 2 can be enhanced.

The motor oil reservoir 74 is a tray arranged in the upper region of the motor accommodation space 501 and opens upward. A dropping hole is formed at a bottom of the motor oil reservoir 74, and the motor 2 is cooled by dropping the lubricating oil CL from the dropping hole. The dropping hole is formed above the coil end 271 of the coil 27 of the stator 25, for example, and the coil 27 is cooled by the lubricating oil CL.

As illustrated in FIGS. 2 and 3, the neutralizing member 6 is arranged in the housing 5 and contacts the extension shaft 8. The neutralizing member 6 includes a neutralizing ring 61 and a brush portion 62. The neutralizing ring 61 has an annular shape and is made of a conductive material such as metal. The neutralizing ring 61 is arranged in the neutralizing member fixing recess 531 of the cover member 53. The neutralizing ring 61 is fixed to the neutralizing member fixing recess 531 by press-fitting. However, the fixing method is not limited thereto, and a method of firmly fixing the neutralizing ring 61 to the neutralizing member fixing recess 531, such as adhesion or welding, can be widely adopted. The neutralizing ring 61 is electrically connected to the cover member 53.

The brush portion 62 is made of a conductive and elastically deformable material. The brush portion 62 is fixed to an inner peripheral surface of the neutralizing ring 61 and is electrically connected to the neutralizing ring 61. That is, the neutralizing member 6 is electrically connected to the housing 5 including the cover member 53. The brush portion 62 protrudes radially inward from the inner peripheral surface of the neutralizing ring 61. A tip end of the brush portion 62 contacts an outer peripheral surface of a contacted portion 82, which will be described later, of the extension shaft 8.

Although a wire member made of a carbon fiber is used as the brush portion 62 in the present preferred embodiment, the present invention is not limited thereto, and a wire member made of a member that is elastically deformable and has conductivity can be widely used. In addition, the brush portion 62 is not limited to the wire member, and may have a film shape having a width in the rotation axis J1 direction and a thickness in the circumferential direction.

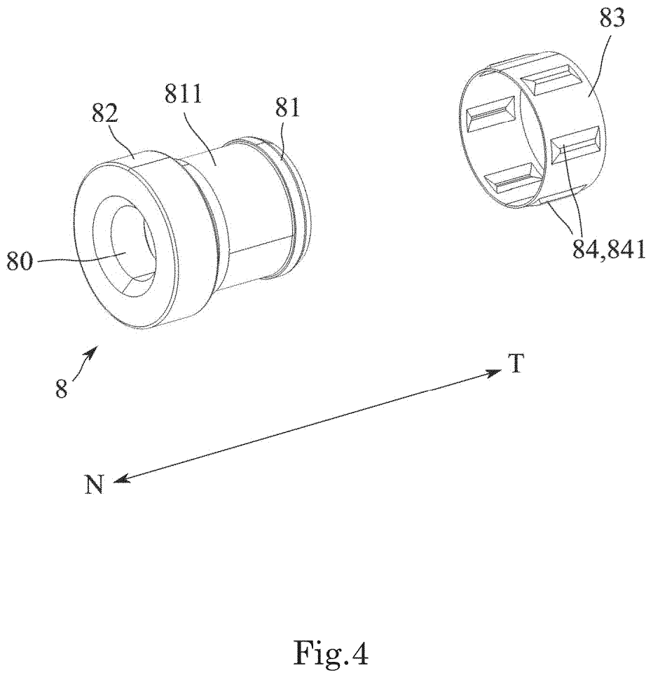

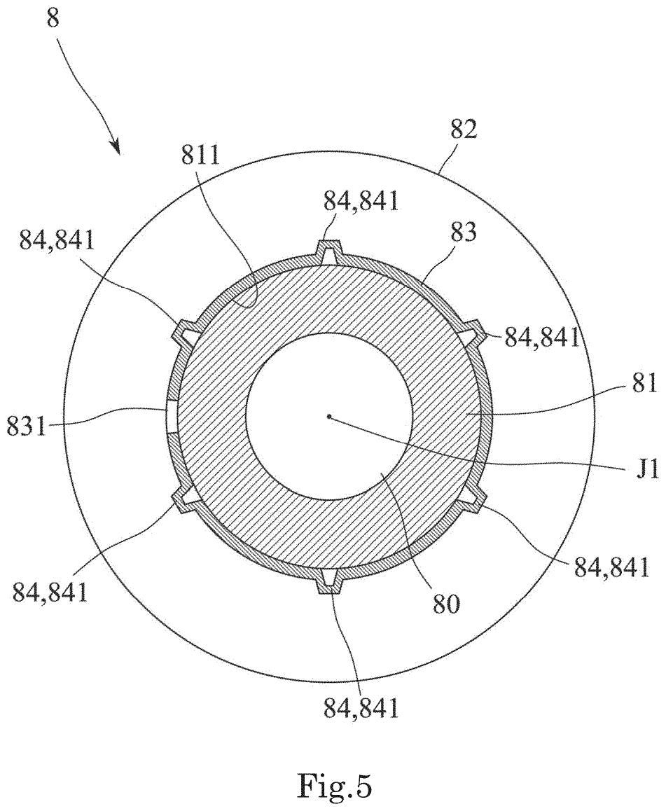

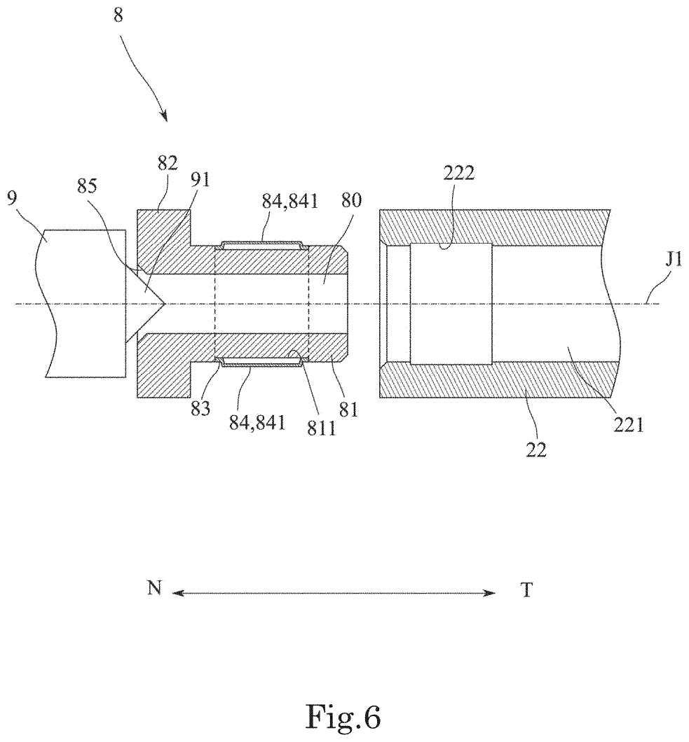

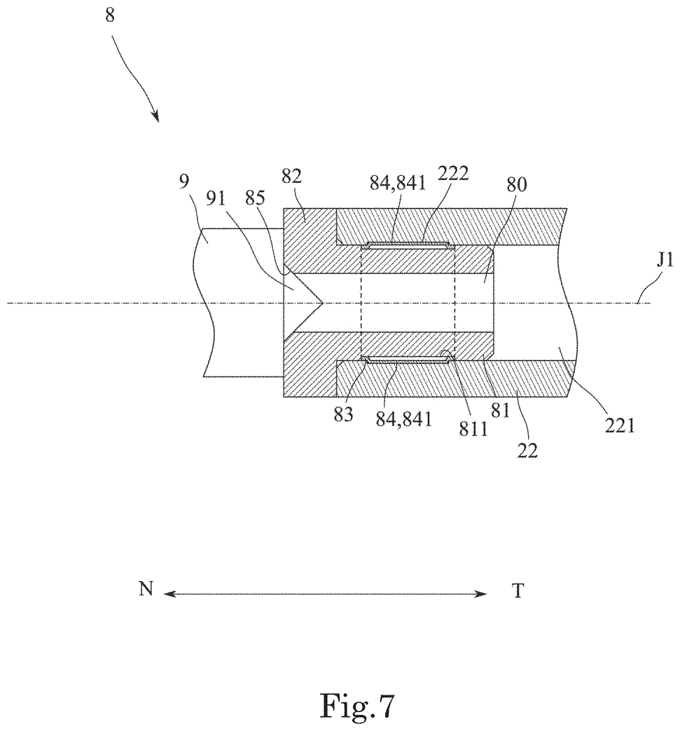

FIG. 4 is an exploded perspective view of the extension shaft 8. FIG. 5 is a cross-sectional view of a fixed portion 81 of the extension shaft 8 taken along a plane orthogonal to the center line. FIG. 6 is a cross-sectional view of the extension shaft 8 attached to the shaft 22 and the shaft 22 taken along the plane including the rotation axis J1. FIG. 7 is a cross-sectional view of the extension shaft 8 attached to the shaft 22 and the shaft 22 taken along the plane including the rotation axis J1.

As illustrated in FIGS. 4 and 5, the extension shaft 8 has a tubular shape. The extension shaft 8 is made of a conductive material such as iron or aluminum. The extension shaft 8 is arranged to contact the shaft 22 at the end portion on the one axial side N of the shaft 22. As a result, the extension shaft 8 is electrically connected to the shaft 22. Note that at least a portion of the extension shaft 8 contacting the shaft 22 is preferably made of the same kind of metal as the shaft 22 in order to suppress contact corrosion of dissimilar metals at the contact portion between the shaft 22 and the extension shaft 8.

As illustrated in FIGS. 4 and 5, the extension shaft 8 includes the fixed portion 81 and the contacted portion 82. The fixed portion 81 has a cylindrical shape extending along the rotation axis J1. The fixed portion 81 is arranged in the hollow portion 221. An end portion on the other axial side T of an outer peripheral surface of the fixed portion 81 is a curved surface whose outer diameter decreases toward the other axial side T. With such a configuration, the fixed portion 81 can be easily inserted into the hollow portion 221 of the shaft 22. Note that an end portion on the one axial side N of an inner peripheral surface of the hollow portion 221 of the shaft 22 may be a curved surface whose inner diameter increases toward the one axial side N. With such a configuration, the fixed portion 81 can be guided to an accurate position. In addition, it is easy to attach the extension shaft 8 to the shaft 22 since the fixed portion 81 is inserted into the hollow portion 221.

As illustrated in FIGS. 4, 5, and 6, the fixed portion 81 includes an outer groove 811 recessed radially inward on the outer peripheral surface, and a strip-shaped member 83 arranged in the outer groove 811. More specifically, the outer groove 811 is continuously formed in the circumferential direction. The strip-shaped member 83 is arranged in the outer groove 811. Details of the strip-shaped member 83 will be described later.

The contacted portion 82 has a circular shape when viewed from the axial direction. An outer diameter of the contacted portion 82 is larger than an inner diameter of the hollow portion 221. In the extension shaft 8, the contacted portion 82 is arranged on the one axial side N of the fixed portion 81. In other words, the contacted portion 82 has a flange shape expanding radially outward from an end portion on the one axial side N of the fixed portion 81.

The strip-shaped member 83 has a tubular shape, and has a discontinuous portion 831 (see FIG. 5) at a part in the circumferential direction. The strip-shaped member 83 has a plurality of protrusions 84 protruding radially outward. That is, the fixed portion 81 has the protrusion 84 radially protruding toward the shaft 22. The protrusion 84 has an outward protrusion 841 protruding radially outward from the outer peripheral surface of the fixed portion 81. As illustrated in FIG. 5, the strip-shaped member 83 has six outward protrusions 841. The six outward protrusions 841 are arranged at equal intervals in the circumferential direction. A tip end of the outward protrusion 841 in the radial direction is located radially outward of the outer peripheral surface of the fixed portion 81.

The strip-shaped member 83 is formed by bending a metal plate, for example. The outward protrusion 841 is formed by extrusion, for example. For this reason, the outward protrusion 841 has a shape obtained by extruding the strip-shaped member 83 outward, and has a deformable shape. The deformation of the outward protrusion 841 may be elastic deformation, but is not limited thereto, and may be plastic deformation.

As described above, the fixed portion 81 of the extension shaft 8 is inserted into the hollow portion 221 from the end portion on the one axial side N of the hollow portion 221 of the shaft 22. That is, the extension shaft 8 has the fixed portion 81 radially overlapping the shaft 22. The fixed portion 81 is press-fitted into the shaft 22. Note that the term “press-fitting” means pressing by applying pressure. In addition, the term “light press-fitting” means pressing by applying a smaller pressure than that in the press-fitting.

As the extension shaft 8 is press-fitted into the shaft 22, the shaft 22 and the extension shaft 8 are electrically connected. In addition, at least the contacted portion 82 of the extension shaft 8 is arranged inside the accommodation space 55 of the housing 5. For this reason, the contacted portion 82 is arranged inside the accommodation space 55. When the fixed portion 81 is fixed to the one axial side N of the hollow portion 221 of the shaft 22, the contacted portion 82 faces the neutralizing ring 61 in the radial direction.

A length of the brush portion 62 protruding radially inward from the inner peripheral surface of the neutralizing ring 61 is longer than a radial distance between the neutralizing ring 61 and an outer peripheral surface of the contacted portion 82. For this reason, a radially inner tip end of the brush portion 62 elastically bends and contacts the outer peripheral surface of the contacted portion 82.

Even when the shaft 22 moves in the axial direction, the radially inner tip end of the brush portion 62 continues to contact the outer peripheral surface of the contacted portion 82. That is, even when the shaft 22 moves in the axial direction, the conductive state between the shaft 22 and the housing 5 is maintained.

Although a wire member made of a carbon fiber is used as the brush portion 62 in the present preferred embodiment, the present invention is not limited thereto, and a wire member made of a member that is elastically deformable and has conductivity can be widely used. In addition, the brush portion 62 is not limited to the wire member, and may have a film shape having a width in the rotation axis J1 direction and a thickness in the circumferential direction.

As illustrated in FIG. 1, the end portion on the one axial side N of the shaft 22 is rotatably supported by the bearing holder 52 through the first bearing 41. The extension shaft 8 is attached to the one axial side N of the shaft 22. The contacted portion 82 of the extension shaft 8 passes through the through-hole 520 and protrudes to the one axial side N.

When the neutralizing member 6 is attached to the neutralizing member fixing recess 531 of the cover member 53, the radially inner tip end of the brush portion 62 of the neutralizing member 6 contacts the outer peripheral surface of the contacted portion 82 of the extension shaft 8. As a result, the brush portion 62 and the extension shaft 8 are electrically connected, and the extension shaft 8 and the neutralizing member 6 are electrically connected. That is, in the motor unit 1, the neutralizing member 6 electrically connected to the housing 5 including the cover member 53 and the extension shaft 8 electrically connected to the shaft 22 are electrically connected to each other, whereby the housing 5 and the shaft 22 are electrically connected to each other. That is, the housing 5 and the shaft 22 have the same potential.

Since the brush portion 62 is made of an elastically deformable material, the electrical connection between the shaft 22 and the neutralizing member 6 is maintained even when the shaft 22 rotates. For this reason, the shaft 22 and the housing 5, that is, an inner ring attached to the shaft 22 and an outer ring attached to the housing 5 of each of the first bearing 41 to the fourth bearing 44 have the same potential, and the electric corrosion of the bearing due to discharge generated on the basis of a potential difference is suppressed. As a result, variations in the rotation of the shaft 22 are suppressed, and the motor unit 1 can be driven stably for a long period of time. In other words, the life of the motor unit 1 can be prolonged.

As illustrated in FIG. 5, the hollow portion 221 penetrates in the axial direction, and the shaft 22 has the inlet 220 that allows the coolant (lubricating oil CL) to flow into the end portion on the other axial side T. The extension shaft 8 has a through-hole 80 penetrating along the rotation axis J1. For this reason, even after the extension shaft 8 is attached to the end portion on the one axial side N of the shaft 22, the shaft 22 maintains the state of passing in the axial direction.

As a result, it is possible to avoid blockage of the hollow portion 221 of the shaft 22. For example, even in the case of wiring a conductive wire in the hollow portion 221 of the shaft 22, the extension shaft 8 is less likely to be an obstacle. In addition, the weight of the shaft 22 can be reduced. Further, the extension shaft 8 has the tubular shape and is arranged on the opposite side of the inlet 220 of the shaft 22, and thus, is less likely to obstruct generation of negative pressure in the hollow portion 221 during the rotation of the shaft 22. As a result, the coolant (lubricating oil CL) flowing in from the inlet 220 is pulled in the axial direction inside the hollow portion 221 by the negative pressure, so that the coolant (lubricating oil CL) can be sent to a portion far from the inlet 220 in the axial direction.

As a result, the rotor 21 and the stator 25 of the motor 2 can be cooled stably with the lubricating oil CL, a decrease in output due to a temperature rise of the motor 2 can be suppressed. That is, in the motor unit 1, the decrease in output can be suppressed over a long period of time.

In addition, an inner diameter of the through-hole 80 of the extension shaft 8 is smaller than the inner diameter of the hollow portion 221 as illustrated in FIG. 5. With such a configuration, it is possible to suppress the coolant (lubricating oil CL) from flowing into the extension shaft 8 due to a step generated by a difference between the inner diameter of the shaft 22 and the inner diameter of the through-hole 80 of the extension shaft 8. As a result, it is possible to prevent the coolant (lubricating oil CL) from entering between the neutralizing member 6 and the extension shaft 8 from the one axial side N of the shaft 22 to form an oil film. As a result, adhesion of the insulating lubricating oil CL to the brush portion 62 is suppressed, and an increase in electric resistance between the brush portion 62 and the contacted portion 82 is suppressed. Accordingly, the potential difference between the shaft 22 and the housing 5 can be reduced.

Next, the press-fitting of the extension shaft 8 into the shaft 22 will be described. An end portion on the one axial side N of an inner peripheral surface of the extension shaft 8 has an inner inclined surface 85 whose inner diameter decreases toward the other axial side T. When the fixed portion 81 of the extension shaft 8 is press-fitted into the hollow portion 221 of the shaft 22, a jig 9 illustrated in FIG. 6 is used. The jig 9 has a conical portion 91 protruding toward the other axial side T. The jig 9 inserts the conical portion 91 from the one axial side N of the through-hole 80 of the extension shaft 8. At this time, an outer peripheral surface of the conical portion 91 contacts the inner inclined surface 85. As a result, the center of the jig 9 exactly overlaps the rotation axis J1, and the jig 9 contacts the end portion on the one axial side N of the extension shaft 8.

Then, the jig 9 is moved to the other axial side T. As a result, the fixed portion 81 of the extension shaft 8 is inserted into the hollow portion 221 of the shaft 22, and the fixed portion 81 is press-fitted into the hollow portion 221 of the shaft 22 (see FIG. 7). As described above, the fixed portion 81 is press-fitted into the hollow portion 221, and the extension shaft 8 is firmly fixed to the shaft 22.

Note that, in the fixing step of fixing the extension shaft 8, the extension shaft 8 having the fixed portion 81, which has the outward protrusion 841 formed on the outer peripheral surface, may be fixed to the hollow portion 221 formed at least on the one axial side N of the shaft 22 after accommodating the motor 2 in the housing 5. In the fixing step, the fixed portion 81 is press-fitted into the hollow portion 221. With this configuration, the extension shaft 8 can be attached even to the shaft 22 of the existing motor unit 1 as in the case of newly manufacturing the motor unit 1.

The inner diameter of the hollow portion 221 of the shaft 22 and an outer diameter of the fixed portion 81 of the extension shaft 8 vary depending on an error or the like generated during machining. As a result, the outer diameter of the fixed portion 81 of the extension shaft 8 may be smaller than the inner diameter of the hollow portion 221 of the shaft 22. In this case, the press-fitting or light press-fitting of the fixed portion 81 into the hollow portion 221 is sometimes difficult.

A radially outer end of the outward protrusion 841 of the strip-shaped member 83 attached to the outer groove 811 of the fixed portion 81 of the extension shaft 8 is located radially outward of the outer peripheral surface of the fixed portion 81. As a result, when the fixed portion 81 is inserted into the hollow portion 221, the outward protrusion 841 is pushed by the inner peripheral surface of the hollow portion 221 and deformed.

As illustrated in FIGS. 6 and 7, the inner peripheral surface of the hollow portion 221 of the shaft 22 has an inner peripheral recess 222 recessed radially outward. Then, at least a part of the outward protrusion 841 is arranged in the inner peripheral recess 222 and contacts an inner surface of the inner peripheral recess 222. When the outward protrusion 841 is deformed and contacts the inner peripheral recess 222, a fixing force in the radial direction acts on the fixed portion 81. As a result, the fixed portion 81 is fixed to the end portion on the one axial side N of the hollow portion 221 of the shaft 22. That is, the extension shaft 8 is fixed in the state of being electrically connected to the shaft 22.

That is, the extension shaft 8 is fixed to the shaft 22 due to the deformation of the outward protrusion 841 even when there is a gap between the fixed portion 81 and the hollow portion 221 by attaching the strip-shaped member 83 to the outer groove 811 of the fixed portion 81.

As the outward protrusion 841 contacts the inner peripheral recess 222, the movement of the extension shaft 8 in the axial direction and the radial direction relative to the shaft 22 is restricted. As a result, detachment of the extension shaft 8 from the shaft 22 is suppressed. In addition, rattling between the extension shaft 8 and the shaft 22 is suppressed, and thus, wear of the extension shaft 8 and the shaft 22 due to the rattling is suppressed.

Note that the inner peripheral recess 222 is not necessarily formed on the inner peripheral surface of the hollow portion 221 of the shaft 22. In such a case, the amount of deformation of the outward protrusion 841 increases at the time of press-fitting. As a result, the extension shaft 8 is more firmly fixed to the shaft 22. Note that the strip-shaped member 83 may be removed and the extension shaft 8 may be press-fitted in a case where a dimensional tolerance between the fixed portion 81 and the hollow portion 221 is a tolerance that allows the press-fitting or the light press-fitting.

In the extension shaft 8, the outward protrusion 841 of the strip-shaped member 83 is deformable within a certain range. For this reason, the extension shaft 8 can be fixed to the shaft 22 even when a gap between the outer peripheral surface of the fixed portion 81 and the inner peripheral surface of the hollow portion 221 changes. In addition, the potential difference between the shaft 22 and the housing 5 decreases since the shaft 22 and the extension shaft 8 are electrically connected and the neutralizing member 6 contacts the extension shaft 8. As a result, a potential difference between the inner ring and the outer ring of each of the bearings 41, 42, 43, and 44 is suppressed to be small, and the electric corrosion of the bearing can be suppressed.

In addition, replacement with the strip-shaped member 83 having a different length in the radial direction of the outward protrusion 841 may be performed according to a gap between the outer peripheral surface of the fixed portion 81 and the inner peripheral surface of the hollow portion 221. It is possible to cope with the dimensional error only by replacing the strip-shaped member 83, the versatility of the extension shaft 8 can be enhanced.

Since the configuration is adopted in which the fixed portion 81 of the extension shaft 8 is inserted into the end portion of the hollow portion 221 of the shaft 22, the length of the extension shaft 8 axially protruding from the end portion of the shaft 22 can be shortened. As a result, it is possible to electrically connect the shaft 22 and the housing 5 while suppressing an increase in size of the motor unit 1 and to suppress the electric corrosion of the bearing.

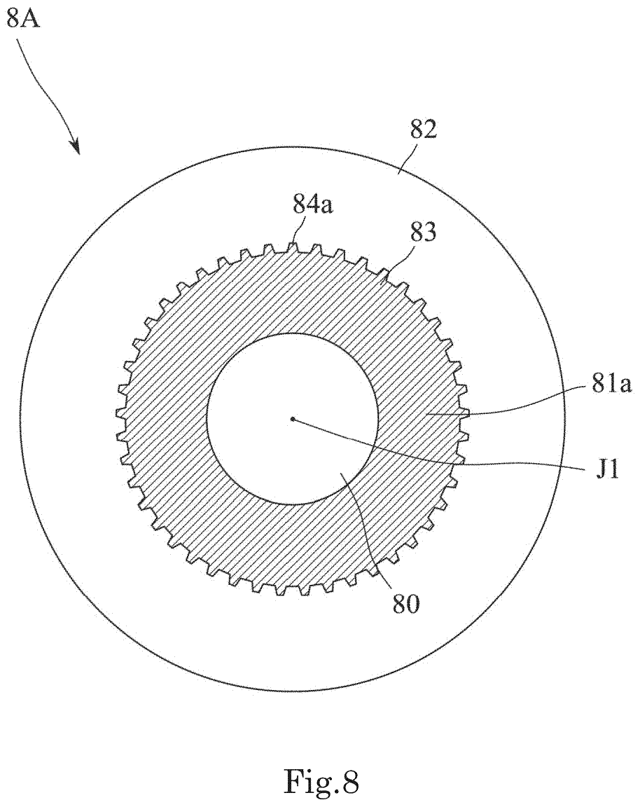

FIG. 8 is a cross-sectional view of an extension shaft 8A, used in a motor unit of a first modification, taken along a plane orthogonal to the rotation axis J1.

The extension shaft 8A of the first modification is different from the extension shaft 8 illustrated in FIG. 5 and the like in that a strip-shaped member is omitted and a protrusion 84a is formed in a fixed portion 81a. The extension shaft 8A has the same configuration as the extension shaft 8 regarding points other than the above difference. For this reason, portions of the extension shaft 8A that are substantially the same as those of the extension shaft 8 are denoted by the same reference signs, and the detailed description of the same portions will be omitted.

As illustrated in FIG. 8, the extension shaft 8A has a plurality of protrusions 84a protruding radially outward from an outer peripheral surface of the fixed portion 81a. The protrusions 84a are arranged at equal intervals in the circumferential direction. The protrusion 84a is formed integrally with the fixed portion 81a.

Note that the protrusion 84a of the extension shaft 8A serves the same function as the outward protrusion 841 of the extension shaft 8. That is, when the extension shaft 8A is attached to the shaft 22, the protrusion 84a is deformed to fix the fixed portion 81a to the hollow portion 221 of the shaft 22. In this manner, since the protrusion 84a is integrated with the fixed portion 81a, it is easy to manufacture the extension shaft 8A.

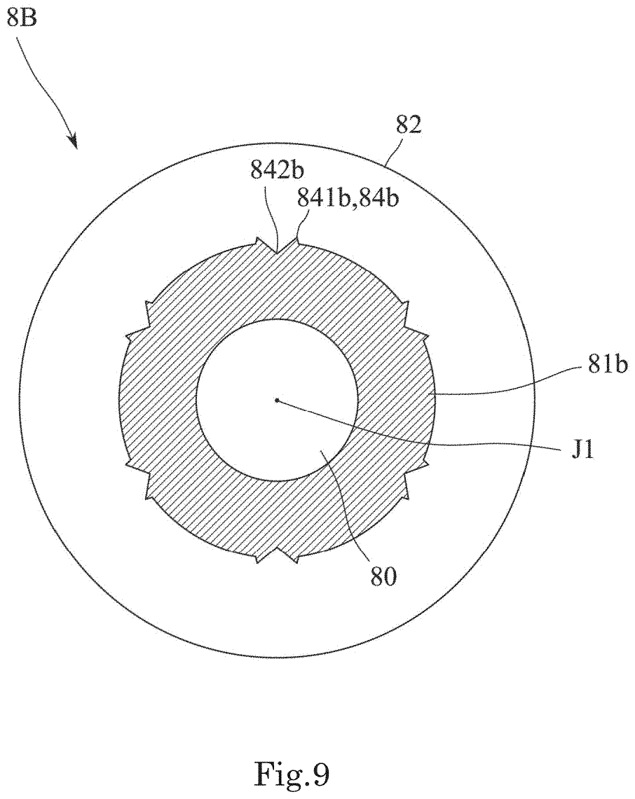

FIG. 9 is a cross-sectional view of an extension shaft 8B, used in a motor unit of a second modification, taken along a plane orthogonal to the rotation axis J1. The extension shaft 8B of the second modification is different from the extension shaft 8A illustrated in FIG. 8 in that a notch 842b adjacent to an outward protrusion 841b is formed in a fixed portion 81b. The extension shaft 8B has the same configuration as the extension shaft 8A regarding points other than the above difference. For this reason, portions of the extension shaft 8B that are substantially the same as those of the extension shaft 8A are denoted by the same reference signs, and the detailed description of the same portions will be omitted.

As illustrated in FIG. 9, the fixed portion 81b of the extension shaft 8B has the notch 842b that is adjacent to a protrusion 84b in the circumferential direction and is radially recessed. More specifically, in the extension shaft 8B, the notch 842b extending in the axial direction is formed by cutting an outer peripheral surface of the fixed portion 81b having a columnar shape. An overhang generated adjacent to the notch 842b when the cutting is performed is defined as the protrusion 84b. That is, the fixed portion 81b of the extension shaft 8B has the notch 842b that is adjacent to the protrusion 84b in the circumferential direction and is radially recessed. Since the configuration is adopted in which the protrusion 84b is formed by cutting, machining is easy.

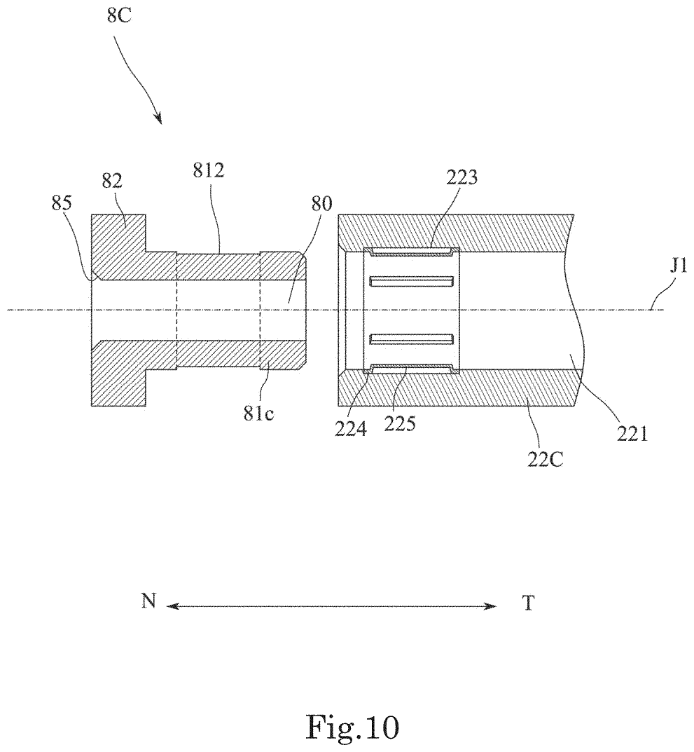

FIG. 10 is a cross-sectional view of an extension shaft 8C and a shaft 22C of a third modification taken along a plane including the rotation axis J1. In the third modification, instead of the protrusion 84, a hollow portion inward protrusion 225 is provided on an inner peripheral surface of the hollow portion 221 of the shaft 22C, and a fixed portion outer peripheral recess 812 is provided on an outer peripheral surface of a fixed portion 81c. The extension shaft 8C and the shaft 22C have same configurations as the extension shaft 8 and the shaft 22 regarding points other than the above difference. For this reason, portions of the extension shaft 8C and the shaft 22C that are substantially the same as those of the extension shaft 8 and the shaft 22 are denoted by the same reference signs, and the detailed description of the same portions will be omitted.

As illustrated in FIG. 10, the inner peripheral surface of the hollow portion 221 includes a hollow portion inner groove 223 recessed radially outward, and a strip-shaped member 224 arranged in the hollow portion inner groove 223. Then, the inner peripheral surface of the hollow portion 221 has the hollow portion inward protrusion 225 protruding radially inward at a portion radially facing the fixed portion 81c. More specifically, the strip-shaped member 224 has the hollow portion inward protrusion 225.

In addition, an outer peripheral surface of the fixed portion 81c has the fixed portion outer peripheral recess 812 recessed radially inward. Then, when the extension shaft 8C is pushed by a certain amount, at least a part of the hollow portion inward protrusion 225 is arranged in the fixed portion outer peripheral recess 812 and contacts an inner surface of the fixed portion outer peripheral recess 812.

When the extension shaft 8C is press-fitted into the one axial side N of the shaft 22C, the hollow portion inward protrusion 225 is pushed by the fixed portion 81c and deformed. At this time, the fixed portion 81c may be accommodated inside the fixed portion outer peripheral recess 812.

With such a configuration, the hollow portion inward protrusion 225 contacts the fixed portion outer peripheral recess 812, so that the movement of the extension shaft 8C in the axial direction and the radial direction relative to the shaft 22C is restricted. As a result, detachment of the extension shaft 8C from the shaft 22C is suppressed. In addition, rattling between the extension shaft 8C and the shaft 22C is suppressed, wear of the extension shaft 8C and the shaft 22C due to the rattling is suppressed. In addition, since the configuration is adopted in which the strip-shaped member 224 is arranged on the shaft 22C, even the extension shaft 8C that varies can be fixed to the shaft 22C. As a result, the versatility of the extension shaft 8C can be enhanced.

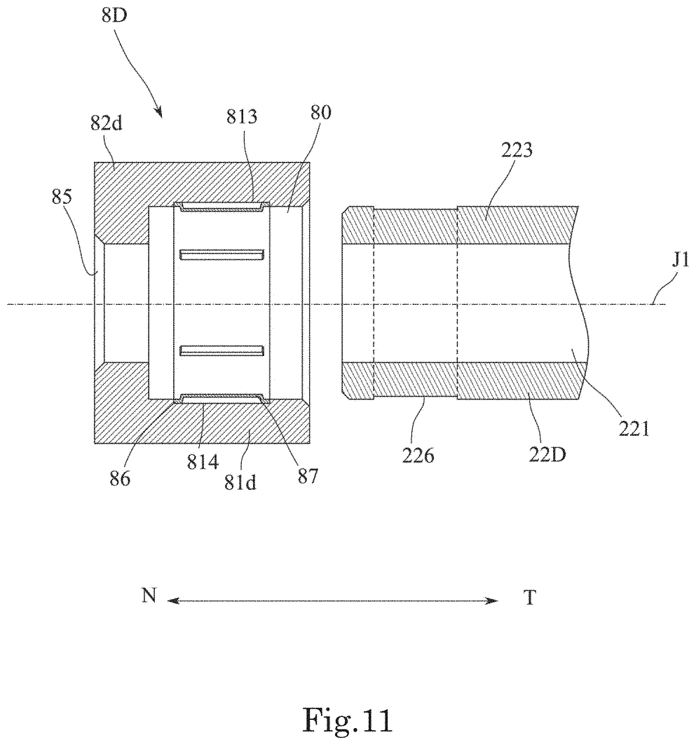

FIG. 11 is a cross-sectional view of an extension shaft 8D and a shaft 22D of a fourth modification taken along a plane including the rotation axis J1. The extension shaft 8D of the fourth modification is different from the extension shaft 8 illustrated in FIG. 6 and the like in terms of adopting a configuration in which a fixed portion 81d has a fixed tubular portion 813 and an end portion on the one axial side N of the shaft 22D is inserted into the fixed tubular portion 813. In addition, when the extension shaft 8D is viewed from the axial direction, a contacted portion 82d has a circular shape having the same outer diameter as the fixed portion 81d. The extension shaft 8D and the shaft 22D have same configurations as the extension shaft 8 and the shaft 22 regarding points other than the above difference. For this reason, portions of the extension shaft 8D and the shaft 22D that are substantially the same as those of the extension shaft 8 and the shaft 22 are denoted by the same reference signs, and the detailed description of the same portions will be omitted.

As illustrated in FIG. 11, an inner peripheral surface of the fixed tubular portion 813 has an inner groove 814 recessed radially outward and a strip-shaped member 86 arranged in the inner groove 814. Then, the fixed portion 81d of the extension shaft 8D has the fixed tubular portion 813 that is open at least at an end portion on the other axial side T. The fixed portion 81d has an inward protrusion 87 protruding radially inward from the inner peripheral surface of the fixed tubular portion 813. More specifically, the strip-shaped member 86 has the inward protrusion 87.

In addition, an outer peripheral surface of the shaft 22D has an outer peripheral recess 226 recessed radially inward.

An end portion on the one axial side N of the shaft 22D is press-fitted into the fixed portion 81d of the extension shaft 8D. That is, the fixed tubular portion 813 is arranged radially outward of the end portion on the one axial side N of the shaft 22D. At this time, the inward protrusion 87 is pressed by the shaft 22D and deformed radially outward. Then, when the shaft 22D is pushed by a certain amount, the inward protrusion 87 is fitted into the outer peripheral recess 226. That is, at least a part of the inward protrusion 87 is arranged in the outer peripheral recess 226 and contacts an inner surface of the outer peripheral recess 226.

With such a configuration, the inward protrusion 87 contacts the outer peripheral recess 226, so that the movement of the extension shaft 8D in the axial direction and the radial direction relative to the shaft 22D is restricted. As a result, detachment of the extension shaft 8D from the shaft 22D is suppressed. In addition, rattling between the extension shaft 8D and the shaft 22D is suppressed, and thus, wear of the extension shaft 8D and the shaft 22D due to the rattling is suppressed.

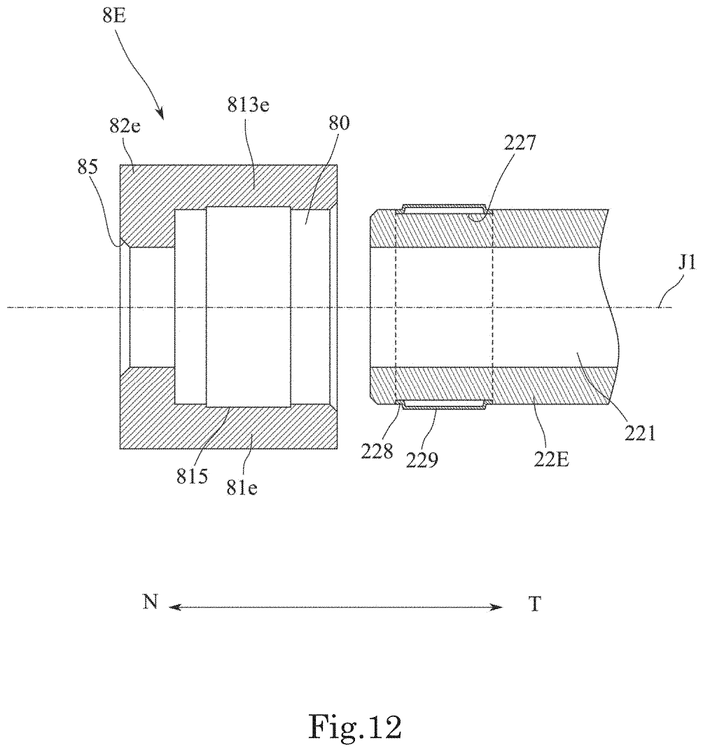

FIG. 12 is a cross-sectional view of an extension shaft 8E and a shaft 22E of a fifth modification taken along a plane including the rotation axis J1. The extension shaft 8E of the fifth modification is different from the extension shaft 8 illustrated in FIG. 6 and the like in terms of adopting a configuration in which a fixed portion 81e has a fixed tubular portion 813e and an end portion on the one axial side N of the shaft 22E is inserted into the fixed tubular portion 813e. In addition, when the extension shaft 8E is viewed from the axial direction, a contacted portion 82e has a circular shape having the same outer diameter as the fixed portion 81e. The extension shaft 8E and the shaft 22E have same configurations as the extension shaft 8 and the shaft 22 regarding points other than the above difference. For this reason, portions of the extension shaft 8E and the shaft 22E that are substantially the same as those of the extension shaft 8 and the shaft 22 are denoted by the same reference signs, and the detailed description of the same portions will be omitted.

As illustrated in FIG. 12, an outer peripheral surface of the shaft 22E has a shaft inner groove 227 recessed radially inward, and a strip-shaped member 228 arranged in the shaft inner groove 227. Then, the fixed portion 81e of the extension shaft 8E has a fixed tubular portion 813e that is open at least at an end portion on the other axial side T. Then, the outer peripheral surface of the shaft 22E has a shaft outward protrusion 229 protruding radially outward. More specifically, the strip-shaped member 228 has the shaft outward protrusion 229.

An inner peripheral surface of the fixed tubular portion 813e has a fixed portion inner peripheral recess 815 that is recessed radially outward.

The end portion on the one axial side N of the shaft 22E is press-fitted into the fixed portion 81e of the extension shaft 8E. That is, the fixed tubular portion 813e is arranged radially outward of the end portion on the one axial side N of the shaft 22E. At this time, the shaft outward protrusion 229 is pressed by the fixed tubular portion 813e and deformed radially inward. Then, when the shaft 22E is pushed by a certain amount, the shaft outward protrusion 229 is fitted into the fixed portion inner peripheral recess 815. That is, at least a part of the shaft outward protrusion 229 is arranged in the fixed portion inner peripheral recess 815 and contacts an inner surface of the fixed portion inner peripheral recess 815.

With such a configuration, the shaft outward protrusion 229 contacts the fixed portion inner peripheral recess 815, so that the movement of the extension shaft 8E in the axial direction and the radial direction relative to the shaft 22E is restricted. As a result, detachment of the extension shaft 8E from the shaft 22E is suppressed. In addition, rattling between the extension shaft 8E and the shaft 22E is suppressed, and thus, wear of the extension shaft 8E and the shaft 22E due to the rattling is suppressed.

While an preferred embodiment of the present invention and modifications thereof have been described above, it will be understood that features, a combination of the features, and so on according to the preferred embodiment are only illustrative and not restrictive, and that an addition, elimination, and substitution of a feature(s), and other modifications can be made without departing from the scope and spirit of the present invention. In addition, the present invention is not to be limited by the preferred embodiment.

For example, the motor unit of the present invention can be used as a drive motor for a hybrid vehicle (HV), a plug-in hybrid vehicle (PHV), and an electric vehicle (EV).

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor unit comprising:
a rotor having a shaft rotatable about a rotation axis;
a stator that surrounds the rotor from a radially outer side;
a housing that accommodates the rotor and the stator;
a bearing that is arranged in the housing and rotatably supports the shaft;
an extension shaft arranged at an end portion on one axial side of the shaft to contact the shaft; and
a neutralizing member that is arranged in the housing and contacts the extension shaft,
wherein the extension shaft has a fixed portion radially overlapping the shaft in a radial direction, and
the fixed portion has a protrusion radially protruding toward the shaft.

2. The motor unit according to claim 1, wherein
the fixed portion of the extension shaft has a notch that is circumferentially adjacent to the protrusion and is radially recessed.

3. The motor unit according to claim 1, wherein
the shaft has a hollow portion that is open at least at the end portion the one axial side,
the fixed portion is arranged in the hollow portion, and
the protrusion has an outward protrusion protruding radially outward from an outer peripheral surface of the fixed portion.

4. The motor unit according to claim 3, wherein
an inner peripheral surface of the hollow portion has an inner peripheral recess recessed radially outward, and
at least a part of the outward protrusion is arranged in the inner peripheral recess and contacts an inner surface of the inner peripheral recess.

5. The motor unit according to claim 3, wherein
an outer peripheral surface of the fixed portion has an outer groove recessed radially inward, and a strip-shaped member arranged in the outer groove, and
the strip-shaped member has the outward protrusion.

6. The motor unit according to claim 1, wherein
the fixed portion has a fixed tubular portion,
the fixed tubular portion is arranged radially outward of the end portion on the one axial side of the shaft, and
the protrusion has an inward protrusion protruding radially inward from an inner peripheral surface of the fixed tubular portion.

7. The motor unit according to claim 6, wherein
an outer peripheral surface of the shaft has an outer peripheral recess recessed radially inward, and
at least a part of the inward protrusion is arranged in the outer peripheral recess and contacts an inner surface of the outer peripheral recess.

8. The motor unit according to claim 6, wherein
the inner peripheral surface of the fixed tubular portion has an inner groove recessed radially outward, and a strip-shaped member arranged in the inner groove, and
the strip-shaped member has the inward protrusion.

9. A motor unit comprising:
a rotor having a shaft rotatable about a rotation axis;
a stator that surrounds the rotor from a radially outer side;
a housing that accommodates the rotor and the stator;
a bearing that is arranged in the housing and rotatably supports the shaft;
an extension shaft arranged at an end portion on one axial side of the shaft to contact the shaft; and
a neutralizing member that is arranged in the housing and contacts the extension shaft,
wherein the extension shaft has a fixed portion radially overlapping the shaft in a radial direction, and
the shaft has a shaft protrusion protruding toward the fixed portion.

10. The motor unit according to claim 9, wherein
the shaft has a notch that is circumferentially adjacent to the shaft protrusion and is radially recessed.

11. The motor unit according to claim 9, wherein
the shaft has a hollow portion that is open at least at the end portion the one axial side,
the fixed portion is arranged in the hollow portion, and
an inner peripheral surface of the hollow portion has a hollow portion inward protrusion protruding radially inward at a portion radially facing the fixed portion.

12. The motor unit according to claim 11, wherein
an outer peripheral surface of the fixed portion has a fixed portion outer peripheral recess recessed radially inward, and
at least a part of the hollow portion inward protrusion is arranged in the fixed portion outer peripheral recess and contacts an inner surface of the fixed portion outer peripheral recess.

13. The motor unit according to claim 11, wherein
an inner peripheral surface of the hollow portion has a hollow portion inner groove recessed radially outward, and a strip-shaped member arranged in the hollow portion inner groove, and
the strip-shaped member has the hollow portion inward protrusion.

14. The motor unit according to claim 9, wherein
the fixed portion of the extension shaft has a fixed tubular portion that is open at least at an end portion on another axial side,
the fixed tubular portion is arranged radially outward of the end portion on the one axial side of the shaft, and
the protrusion has a shaft outward protrusion protruding radially outward from an outer peripheral surface of the shaft.

15. The motor unit according to claim 14, wherein
an inner peripheral surface of the fixed tubular portion has a fixed portion inner peripheral recess recessed radially outward, and
at least a part of the shaft outward protrusion is arranged in the fixed portion inner peripheral recess and contacts an inner surface of the fixed portion inner peripheral recess.

16. The motor unit according to claim 14, wherein
an outer peripheral surface of the shaft has a shaft inner groove recessed radially inward, and a strip-shaped member arranged in the shaft inner groove, and
the strip-shaped member has the shaft outward protrusion.

17. The motor unit according to claim 1, wherein
the extension shaft has a tubular shape extending along a rotation axis, and
an end portion on the one axial side of an inner peripheral surface of the extension shaft has an inner inclined surface whose inner diameter decreases toward the other axial side.

18. The motor unit according to claim 9, wherein
the extension shaft has a tubular shape extending along a rotation axis, and
an end portion on the one axial side of an inner peripheral surface of the extension shaft has an inner inclined surface whose inner diameter decreases toward the other axial side.

19. A method for manufacturing a motor unit in which a motor that includes a rotor having a shaft rotatable about a rotation axis and a stator surrounding the rotor from a radially outer side is accommodated in a housing, the method comprising
a fixing step of accommodating the motor in the housing, and then, fixing an extension shaft having a fixed portion to a hollow portion formed on at least one axial side of the shaft, the fixed portion having an outward protrusion formed on an outer peripheral surface,
wherein the fixed portion is press-fitted into the hollow portion in the fixing step.
